(19) United States
(12) Patent Application Publication
(10) Pub. No.: US 2024/0078539 A1
(43) Pub. Date: Mar. 7, 2024

(54) CONSTRUCTING A COLD WALLET USING A SERVER-SIDE HARDWARE SECURITY MODULE

(71) Applicant: International Business Machines Corporation, Armonk, NY (US)

(72) Inventors: Takuya Nakaike, Yokohama-shi (JP); Moriyoshi Ohara, Yokohama-shi (JP); Peter James DeMeo, Singapore (SG); Angel Nunez Mencias, Stuttgart (DE)

(21) Appl. No.: 17/939,891

(22) Filed: Sep. 7, 2022

(51) Int. Cl. G06Q 20/38; G06Q 20/40

(52) U.S. Cl. CPC G06Q 20/3825; G06Q 20/3829; G06Q 20/4014; G06Q 2220/00

(57) ABSTRACT

A computer-implemented method, in accordance with one embodiment, includes receiving, at an offline input bridge module, a transaction order and a corresponding cryptogram. The transaction order and the cryptogram are transferred from the input bridge module to a disconnected vault module. The input bridge module is discarded in response to the transfer of the transaction order and cryptogram. The transaction order is converted to an unsigned transaction, using the disconnected vault module. The unsigned transaction and cryptogram are transferred to an offline hardware security module. A seed is unwrapped from the cryptogram, using the hardware security module. A key for signing the transaction is generated, using the hardware security module. The signed transaction is transferred to an offline output bridge module, and from the output bridge module to an online module. The output bridge module is discarded in response to the transfer of the signed transaction and the cryptogram therefrom.

### BACKGROUND

The present invention relates to the management of private keys that are used to sign transactions for digital assets such as cryptocurrencies, and more specifically, this invention relates to providing a secure key material transit and signing mechanism using a third party cold wallet that manages the private keys.

Sensitive data including private keys to sign digital asset transactions are considered safest when stored or decrypted in cold storage. Cold storage refers to storage that is not connected to a public network, thereby minimizing the risk of network-based intrusion. In addition, cold storage may be physically secured as well, e.g., stored in a secure environment.

Cold storage may be provided to users as a service, e.g., as part of a custodial platform. FIG. 4 depicts a traditional custodial-type cold storage platform 400 having hot side 402, e.g., a server and/or storage connected to a network, and cold side 404, e.g., a server and/or cold storage not connected to a public network. A user's private key can be stored in a storage on the hot side 402 in encrypted form, e.g., as a cryptogram 406 in a wallet such as a higher quality, deterministic wallet. In a common approach, the wallet has a seed (e.g., the user's root private key) that is encrypted using a master encryption key. In some approaches, the encrypted seed is encrypted again and/or encapsulated to make access to the key virtually impossible.

When a user wants to perform a transaction regarding a digital asset, such as the user's cryptocurrency, a request for the transaction is received at a server coupled to the hot storage, e.g., from the user via the internet. A partially approved transaction order 408 is created and a process is performed to effect the transaction. The cryptogram 406 is moved to a portable storage apparatus 410 and a human physically moves the portable storage apparatus 410 to the cold side 404. The access to the cryptogram 406 can be protected by a hardware key such as a USB key, a YUBIKEY®, and WORM tape.

### SUMMARY

A computer-implemented method, in accordance with one embodiment, includes receiving, at an offline input bridge module, a transaction order and a corresponding cryptogram. The transaction order and the cryptogram are transferred from the input bridge module to a disconnected vault module. The input bridge module is discarded in response to the transfer of the transaction order and the cryptogram therefrom. The transaction order is converted to an unsigned transaction, using the disconnected vault module. The unsigned transaction and cryptogram are transferred to an offline hardware security module. A seed is unwrapped from the cryptogram, using the hardware security module. A key for signing the transaction is generated, using the hardware security module. The signed transaction is transferred to an offline output bridge module. The signed transaction is transferred from the output bridge module to an online module. The output bridge module is discarded in response to the transfer of the signed transaction and the cryptogram therefrom.

A computer program product for protecting a private key in a remote cold storage environment, in accordance with one embodiment, includes one or more computer readable storage media, and program instructions collectively stored on the one or more computer readable storage media, the program instructions comprising program instructions to perform the foregoing method.

A computer-implemented method, in accordance with another embodiment, includes connecting to an online module for receiving transaction orders, and disconnecting from the online module in response to receiving the transaction orders. A signing service is provisioned, the signing service having a hardware security module for signing transactions derived from the transaction orders. The signing service is deprovisioned in response to the transactions being signed. A connection is made to the online module for returning the signed transactions to the online module. The connection to the online module is disconnected in response to return of the signed transactions.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIGS. 2A-2H are a graphical depiction of an exemplary method, along with associated components, in accordance with one embodiment of the present invention.

FIG. 3 is a flowchart of a method, in accordance with one embodiment of the present invention.

FIG. 4 depicts a traditional custodial-type cold storage platform.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for secure signing of transactions for digital assets using private keys that are stored and/or decrypted in cold storage. Preferably, the system is quantum safe if the cold storage supports a quantum safe encryption/decryption, and operable on the server side and/or in a cloud.

In one general embodiment, a computer-implemented method includes receiving, at an offline input bridge module, a transaction order and a corresponding cryptogram. The transaction order and the cryptogram are transferred from the input bridge module to a disconnected vault module. The input bridge module is discarded in response to the transfer of the transaction order and the cryptogram therefrom. The transaction order is converted to an unsigned transaction, using the disconnected vault module. The unsigned transaction and cryptogram are transferred to an offline hardware security module. A seed is unwrapped from the cryptogram, using the hardware security module. A key for signing the transaction is generated, using the hardware security module. The signed transaction is transferred to an offline output bridge module. The signed transaction is transferred from the output bridge module to an online module. The output bridge module is discarded in response to the transfer of the signed transaction and the cryptogram therefrom.

In another general embodiment, a computer program product for protecting a private key in a remote cold storage environment includes one or more computer readable storage media, and program instructions collectively stored on the one or more computer readable storage media, the program instructions comprising program instructions to perform the foregoing method.

In another general embodiment, a computer-implemented method includes connecting to an online module for receiving transaction orders, and disconnecting from the online module in response to receiving the transaction orders. A signing service is provisioned, the signing service having a hardware security module for signing transactions derived from the transaction orders. The signing service is deprovisioned in response to the transactions being signed. A connection is made to the online module for returning the signed transactions to the online module. The connection to the online module is disconnected in response to return of the signed transactions.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code for secure transactions of digital assets stored in cold storage in block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

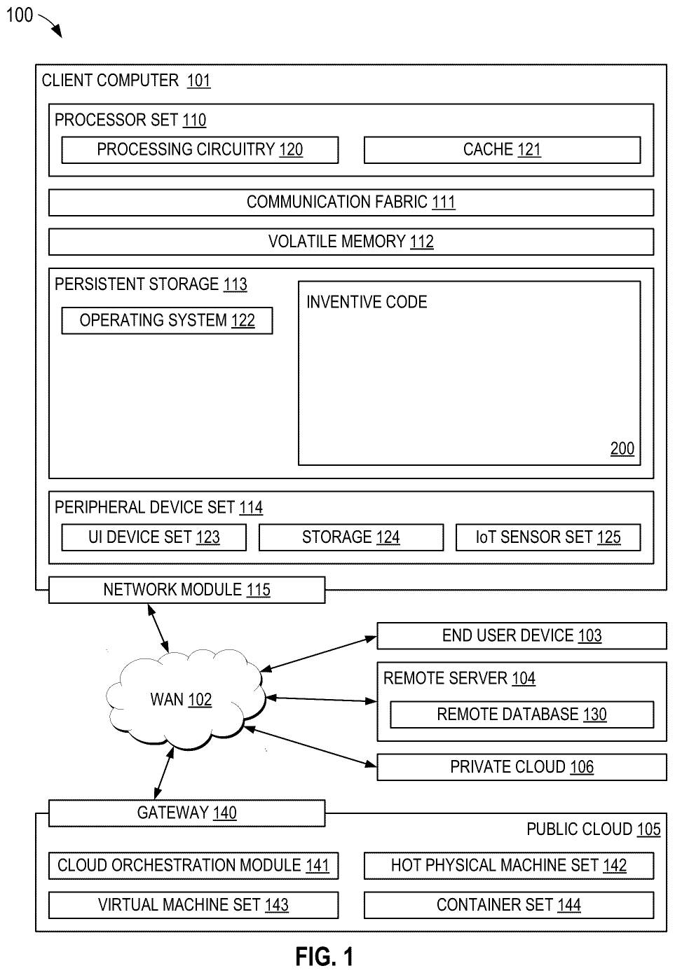

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned above, in a conventional custodial-type cold storage platform, the primary security vulnerability is the human transit risk. The methodology presented herein, according to various embodiments, fundamentally removes that risk.

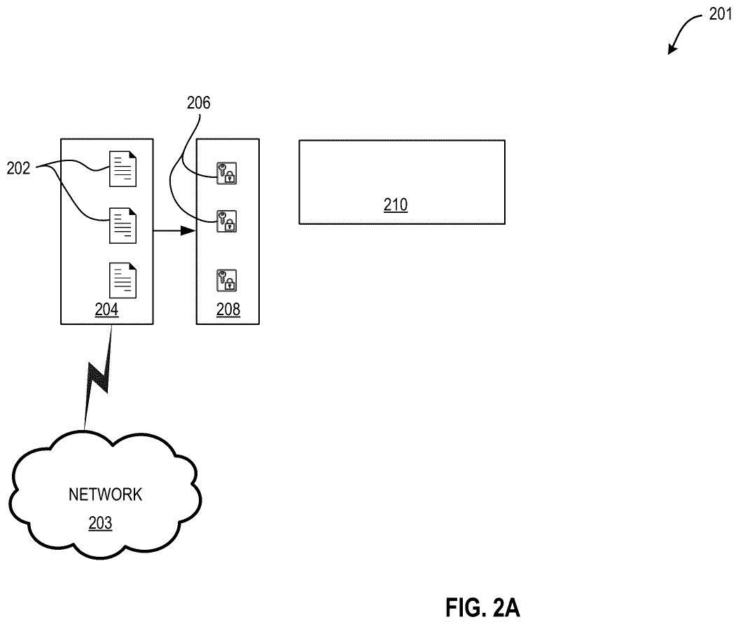

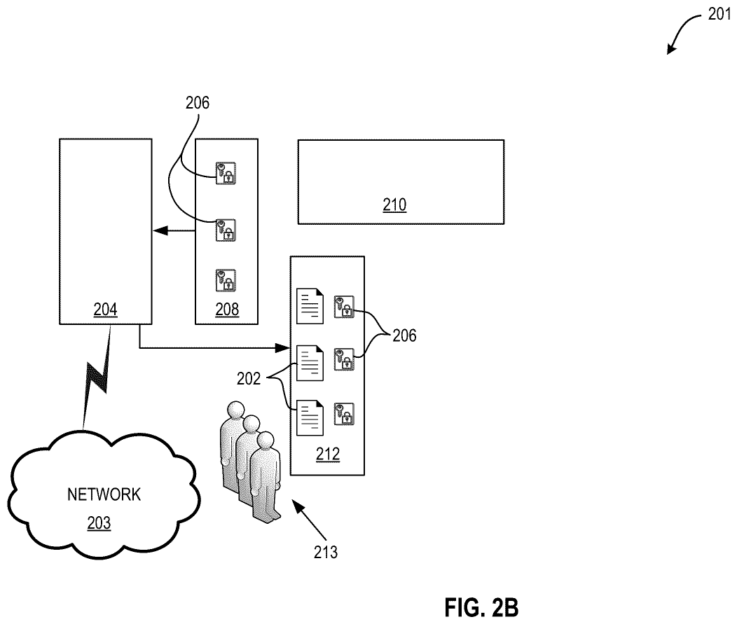

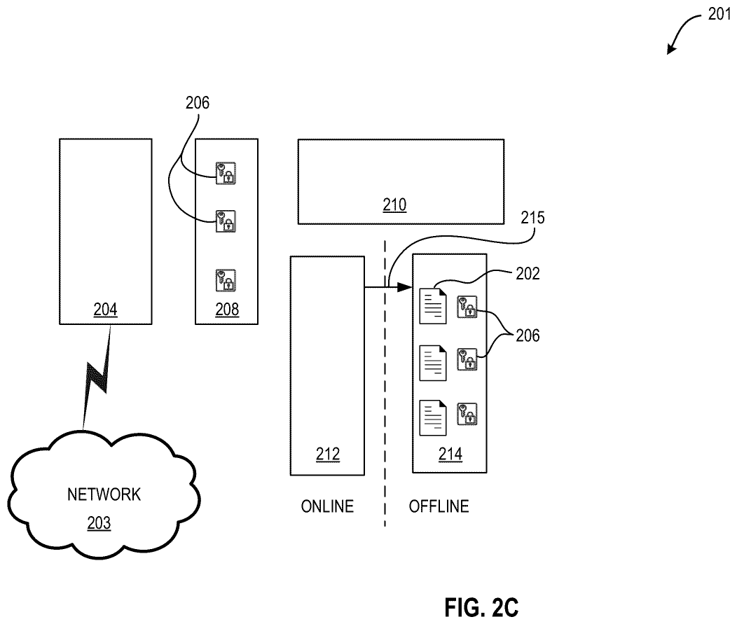

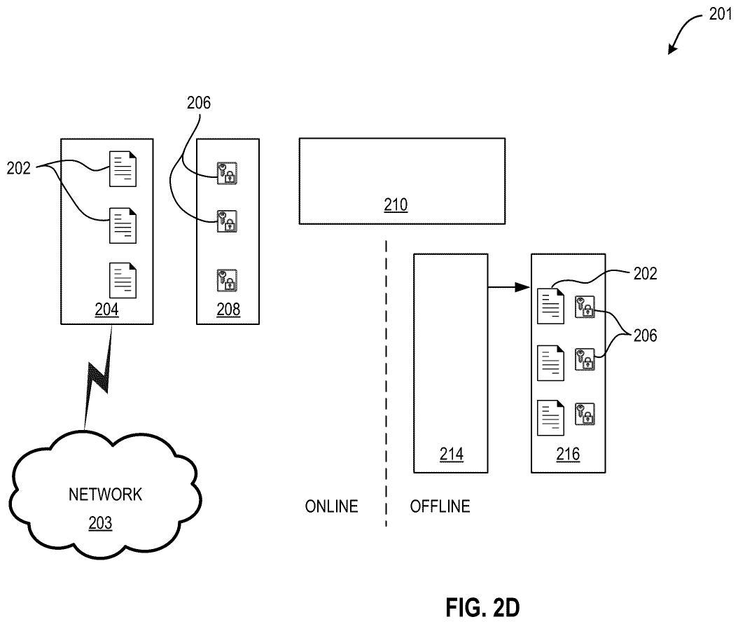

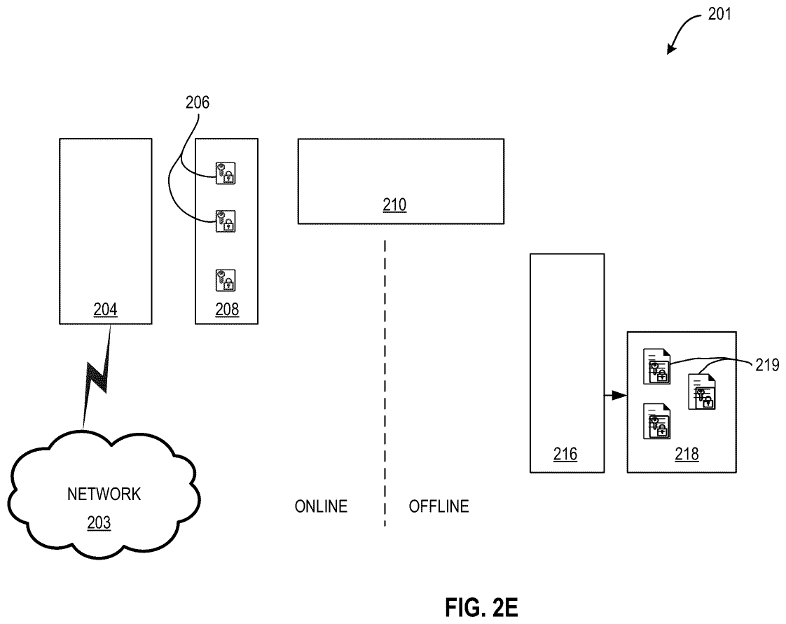

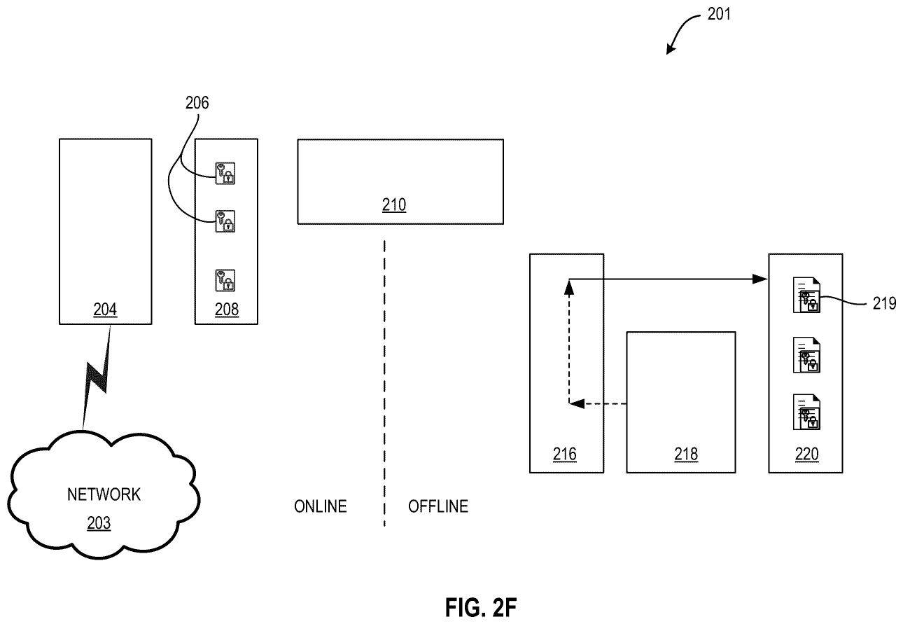

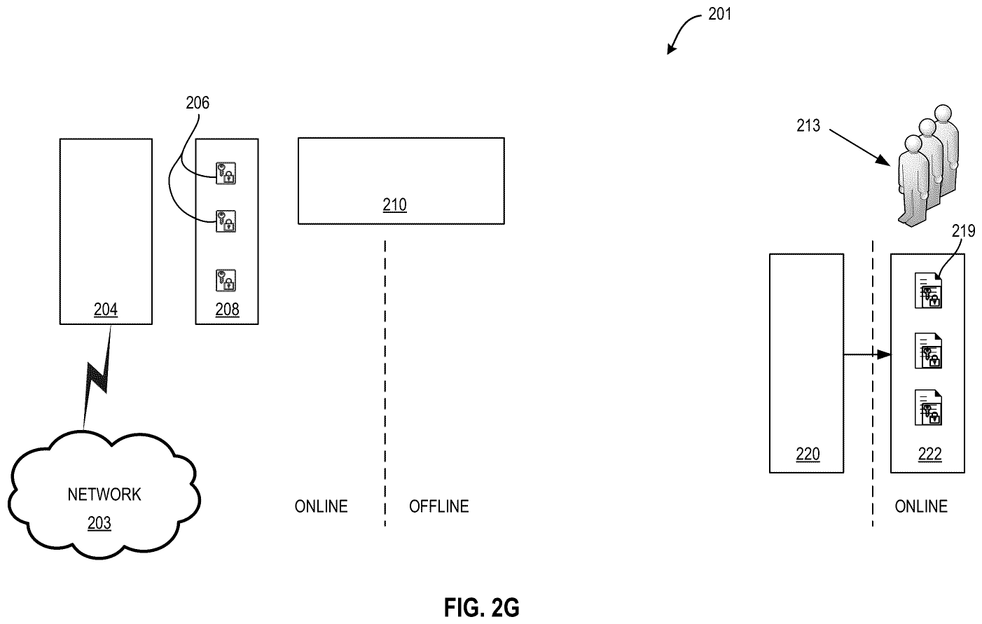

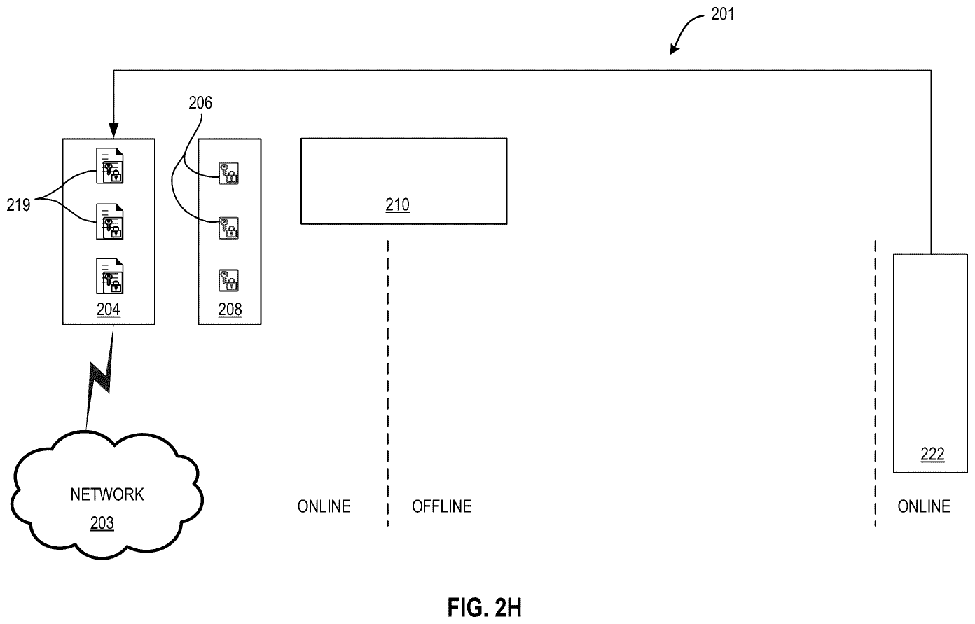

Now referring to FIGS. 2A-2H, a sequence of an exemplary method 201, along with associated components, is graphically depicted, according to one illustrative embodiment. The method 201 may be performed in accordance with the present invention in any of the environments depicted in FIG. 1, among others, in various embodiments. Of course, more or fewer operations and/or components than those specifically described in FIGS. 2A-2H may be included in method 201, as would be understood by one of skill in the art upon reading the present descriptions.

Each of the steps of the method 201 may be performed by any suitable component of the operating environment. For example, in various embodiments, the method 201 may be partially or entirely performed by servers and storage devices, or some other device having one or more processors therein. The processor, e.g., processing circuit(s), chip(s), and/or module(s) implemented in hardware and/or software, and preferably having at least one hardware component may be utilized in any device to perform one or more steps of the method 201. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 2A, the method 201 may initiate with receipt of one or more transaction orders 202 for approved ingress and/or egress of digital asset(s) to be signed by using private keys that are stored or decrypted in cold storage. The transaction orders 202 may originate from any source, e.g., may be created in response to receiving user requests via a network 203, may be received from a computer, etc. As shown, several transaction orders 202 reside on an interface module 204 in this example. A conventional approval procedure may be performed to approve each of the transaction orders 202 prior to processing the transaction orders 202 in this method 201, e.g., to confirm validity of the transaction order, to ensure the transaction order is authorized by the owner of the underlying digital asset, etc.

Private keys of one or more users are stored in a storage system 208, e.g., in a database. Each key may be a seed, such as a blockchain seed. Each key is preferably stored in the storage system 208 as a cryptogram 206. More preferably, each key is stored as a cryptogram 206, and the cryptogram 206 is further fortified, e.g., by being wrapped and/or encrypted. In one exemplary approach, the cryptogram 206 is a post quantum resistant Kyber encapsulated Master Encryption Key wrapped seed cryptogram.

An orchestration module 210 initiates next steps in the process. Preferably, the orchestration module 210 has a start time that is based on a policy that is defined by the client, ideally that is made tamper resistant and immutable, e.g., only the client can change the policy. The start times may be made irregular, so as to enhance the unpredictability of when the process will be performed. Also preferably, the orchestration module 210 is running inside a trusted execution environment of any type. For example, the trusted execution environment may be a dilithium-signed trusted execution environment, signed with a signature which is also a post quantum lattice curve. This allows one to determine whether the trusted execution environment has been tampered with by, e.g., a quantum attack, because a hash can be created from the dilithium signed signature, and the hash checked to determine whether there has been an attack. If an attack is detected, the method 201 can be stopped.

In some approaches, the orchestration module 210 enforces a timing policy whereby if various parts of the method 201, or the entire method itself, are not performed within a predefined period of time, the method stops, and preferably relevant parts of the system are locked down. This further enhances security by ensuring that there is not enough time for a nefarious actor to obtain any of the assets.

Referring to FIG. 2B, when the predetermined start time occurs, the orchestration module 210 initiates the process of moving assets (cryptograms 206 and transaction orders 202) out of the storage system 208 to the cold storage portion of the overall architecture to process the transaction orders 202.

A check may be performed to ensure that all the transaction orders 202 to be processed in this batch, and the associated seeds (cryptograms 206) are identified. Accordingly, the transaction orders 202 and cryptograms 206 are sent to a confirmation module 212. A set of verifiers 213, e.g., individuals who are operators confirm that the confirmation module 212 has the correct set of transactions to proceed with. The verifiers 213 may provide confirmation in any desired manner. The confirmation may be based on a quorum, e.g., more verifiers 213 must verify the completeness of the items in the confirmation module 212 than do not verify the completeness to provide verification.

Preferably, the confirmation module 212 acts as a trusted execution environment having one or more of the following characteristics: single use, stateless, hardware-isolated, quantum-resistant signed, and temporary.

Referring to FIG. 2C, once the proper confirmation(s) are received, the process of moving things from the online to the offline worlds occurs.

The verified transaction orders 202 and the corresponding cryptograms 206 are transferred from the confirmation module 212 to an input bridge module 214, which functions as an input bridge for inputting the transaction orders 202 and the cryptograms 206. The input bridge module 214 is a trusted execution environment that has no IP address, and is offline. Preferably, the input bridge of the input bridge module 214 has one or more of the following characteristics: single use, stateless, hardware-isolated, quantum-resistant signed, and temporary.

A temporary connection 215 is formed between the confirmation module 212 and the input bridge module 214, during which the transaction orders 202 and the cryptograms 206 are moved to the input bridge module 214. Preferably, the temporary connection 215 is a single use, unidirectional communications link. In particularly preferred embodiments, the temporary connection 215 is a single use, unidirectional internal Queued Direct I/O (iQDIO, also known as a HiperSocket) point-to-point in-memory communications connection. The temporary connection 215 is preferably discarded, e.g., destroyed, after the transfer.

Referring to FIG. 2D, after the transaction orders 202 and the cryptograms 206 are moved over to the input bridge module 214, the confirmation module 212 is discarded, and a disconnected vault module 216 is connected to the input bridge module 214. The transaction requests and cryptograms 206 are transferred to the disconnected vault module 216. At this point, everything having the transaction requests and cryptograms 206 is offline.

Referring to FIG. 2E, after the transaction orders 202 and the cryptograms 206 are moved over to the disconnected vault module 216, which is also offline. The input bridge module 214 is discarded in response to the transfer. Also, after the transaction orders 202 and the cryptograms 206 are moved over to the disconnected vault module 216, the unsigned transaction requests are converted into unsigned transactions, e.g., blockchain unsigned transactions.

Next, the signing process occurs. The cryptograms 206 and the unsigned transactions are transferred from the disconnected vault module 216 to an offline hardware security module 218.

The hardware security module 218, that is in communication with the disconnected vault module 216, unwraps the seeds from the cryptograms 206, e.g., using any known technique. Each seed is then used to generate a private key pair, e.g., using any known technique, which in turn is used to sign the associated transaction, e.g., using any known technique. Preferably, the only thing returned to the disconnected vault module 216 is the signed transaction. Ideally, the key materials inside of the offline hardware security module 218 are discarded.

Preferably, the disconnected vault module 216 has a credential to access the hardware security module 218, and that credential is used during the time when the transactions are being signed in the hardware security module 218.

Referring to FIG. 2F, the signed transactions 219 are transferred to an output bridge module 220. Preferably, the output bridge module 220 acts as a trusted execution environment having one or more of the following characteristics: single use, stateless, hardware-isolated, and temporary.

As shown in FIG. 2G, the signed transactions 219 are moved to a final review module 222, preferably using a single-use, unidirectional connection, e.g., that is similar to the ephemeral connection noted above. The signed transactions 219 are reviewed, e.g., by verifiers 213, to confirm any desired information, such as that the transactions were in fact signed, that the transactions that were signed were the same number that were supposed to be signed according to the prior approval, etc. If an anomaly is found, the process can be stopped to ensure no nefarious behavior has occurred.

The verified, signed transactions 219 are output by the final review module 222 for further processing. As shown in FIG. 2H, the signed transactions 219 may be passed back to the interface module 204 for further processing. For example, the user's authorized transaction may be broadcast to a blockchain.

In a preferred aspect of the illustrative embodiment of FIGS. 2A-2H, the architecture of the system depicted in the flow diagrams has a number of technical features such as stateless single use offline modules, with temporary trusted execution environments that use unidirectional in-memory internal Queued Direct I/O (iQDIO), also known as a HiperSocket, for secure transfers.

In one approach, the modules are each implemented in discrete hardware devices. In another approach, some or all of the modules are implemented in a common computer system, e.g., as one or more containers, in one or more dedicated virtual machines, etc. For example, the offline modules may run in a virtual machine or container that is either never connected to a network, or disconnected from all networks while the offline portions of the method 201 are performed. Thus, where modules 212 and 214 are implemented on the same computer system, module 214 would be run as a separate, offline, trusted execution environment within the computer system. Module 214 would allow unidirectional in-memory iQDIO (e.g., HiperSocket) according to the method 201 above, but when provisioned, would never be in communication with a network.

Moreover, no human interaction is needed in the offline portion of the process, thereby eliminating the human-based drawbacks and dangers of current state of the art cold storage systems. For example, comparing the method 201 to conventional cold storage systems, the present method removes the manual transit of key material and, in some approaches, replaces it with two manual reviews.

Further, the foregoing implementation is quantum safe in preferred embodiments.

A further advantage of various embodiments described herein is that offline processing can be performed on a machine that is physically connected to the Internet or to a data center, but the cold portion of the process is made completely offline. This enables creation of an immutable tamperproof policy to dictate how the cold storage system works. Accordingly, even if the humans involved in verifying the transactions are compromised, the keys remain secure because the human element has been removed.

Moreover, a great advantage of some embodiments is that the methodology presented herein enables secure cold storage on a cloud, which has heretofore been impossible to achieve.

Likewise, the methodology presented herein enables secure server-side cold storage.

Some approaches may use a security model that identifies a malicious change to a transaction order, at some point in the process or anywhere in the process. For instance, a jellyfish merkle tree may be used to establish state. Then, if anyone tries to maliciously alter a transaction order, the attempt would be identified, and the order would not be processed. This adds a layer of security over the cold storage techniques described herein.

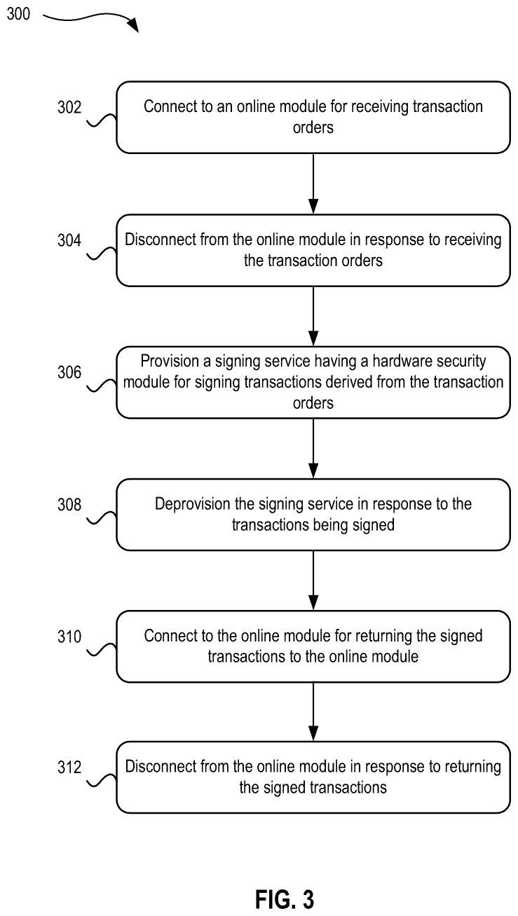

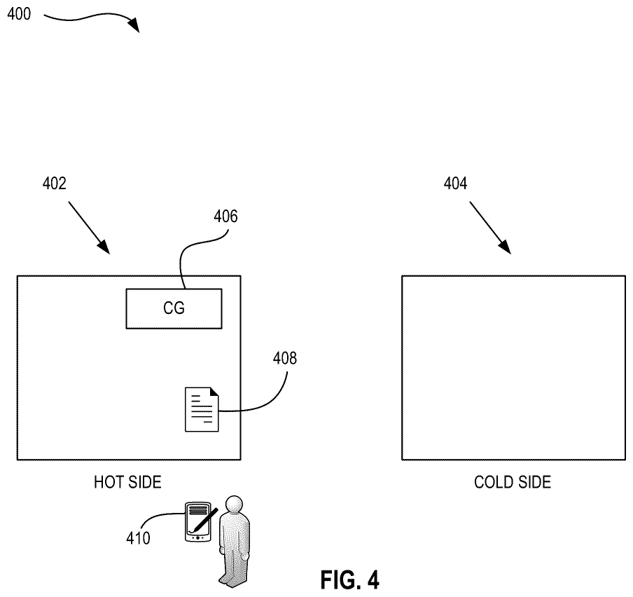

Now referring to FIG. 3, a sequence of an exemplary method 300 that uses a reduced time window for provisioning a signing service to reduce the risk for attacks through a network, according to one embodiment. The method 300 may be performed in accordance with the present invention in any of the environments depicted in FIGS. 1-2H, among others, in various embodiments. Of course, more or fewer operations and/or components than those specifically described in conjunction with FIGS. 2A-2H may be included in method 300, as would be understood by one of skill in the art upon reading the present descriptions.

Each of the steps of the method 300 may be performed by any suitable component of the operating environment, which itself may include a server-side system, a cloud, etc. For example, in various embodiments, the method 300 may be partially or entirely performed by servers and storage devices, or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

In operation 302, a connection is made to an online module for receiving transaction orders. The online module may be connected to a public and/or private network.

In operation 304, the connection to the online module is terminated in response to receiving the transaction orders.

In operation 306, a signing service, or equivalently portions thereof, having a hardware security module is provisioned for signing transactions derived from the transaction orders. In one approach, the signing service runs on a virtual machine. In another approach, the signing service runs on a container.

The transaction orders are provided to the signing service for signing of the associated transactions. In one approach, a messaging service module positioned between the online module and the signing service is used to receive the transaction orders and return the signed transactions, wherein the messaging service module is never connected to both the online module and the signing service at the same time.

In operation 308, the signing service, or equivalently portions thereof, is deprovisioned in response to the transactions being signed.

In operation 310, a connection is made to the online module for returning the signed transactions to the online module.

In operation 312, the connection to the online module is terminated in response to returning the signed transactions.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, at an offline input bridge module, a transaction order and a corresponding cryptogram;
transferring, from the input bridge module to a disconnected vault module, the transaction order and the cryptogram;
discarding the input bridge module in response to the transfer of the transaction order and the cryptogram therefrom;
converting, using the disconnected vault module, the transaction order to an unsigned transaction;
transferring the unsigned transaction and cryptogram to an offline hardware security module;
unwrapping, using the hardware security module, a seed from the cryptogram;
generating, using the hardware security module, a key for signing the transaction;
transferring the signed transaction to an offline output bridge module;
transferring the signed transaction from the output bridge module to an online module; and
discarding the output bridge module in response to the transfer of the signed transaction and the cryptogram therefrom.

2. The computer-implemented method of claim 1, wherein the transaction order is verified, wherein the input bridge module receives the verified transaction order from a verification module via a temporary connection that is discarded in response to the verified transaction order being transferred to the input bridge module.

3. The computer-implemented method of claim 1, wherein the input bridge module receives the transaction order and the cryptogram from an online confirmation module that operates in conjunction with at least one human verifier to verify the transaction order.

4. The computer-implemented method of claim 1, wherein the online module is a final review module, wherein the final review module operates in conjunction with at least one human verifier to verify the signed transaction.

5. The computer-implemented method of claim 1, wherein the transaction order and the cryptogram are received by the input bridge module via a single use, unidirectional temporary connection that is discarded in response to the transaction order and the cryptogram being transferred to the input bridge module; wherein the signed transaction is transferred from the output bridge module to the online module via a single use, unidirectional temporary connection that is discarded in response to the transaction being transferred to the online module.

6. The computer-implemented method of claim 1, wherein the hardware security module is located in a cloud.

7. A system, comprising:
a processor; and
logic integrated with the processor, executable by the processor, or integrated with and executable by the processor, the logic being configured to perform the method of claim 1.

8. A computer program product for protecting a private key in a remote cold storage environment, the computer program product comprising:
one or more computer readable storage media, and program instructions collectively stored on the one or more computer readable storage media, the program instructions comprising:
program instructions to receive, at an offline input bridge module, a transaction order and a corresponding cryptogram;
program instructions to transfer, from the input bridge module to a disconnected vault module, the transaction order and the cryptogram;
program instructions to discard the input bridge module in response to the transfer of the transaction order and the cryptogram therefrom;
program instructions to convert, using the disconnected vault module, the transaction order to an unsigned transaction;
program instructions to transfer the unsigned transaction and cryptogram to an offline hardware security module;
program instructions to unwrap, using the hardware security module, a seed from the cryptogram;
program instructions to generate, using the hardware security module, a key for signing the transaction;
program instructions to transfer the signed transaction to an offline output bridge module;
program instructions to transfer the signed transaction from the output bridge module to an online module; and
program instructions to discard the output bridge module in response to the transfer of the signed transaction and the cryptogram therefrom.

9. The computer program product of claim 8, wherein the transaction order is verified, wherein the input bridge module receives the verified transaction order from a verification module via a temporary connection that is discarded in response to the verified transaction order being transferred to the input bridge module.

10. The computer program product of claim 8, wherein the input bridge module receives the transaction order and the cryptogram from an online confirmation module that operates in conjunction with at least one human verifier to verify the transaction order.

11. The computer program product of claim 8, wherein the online module is a final review module, wherein final review module operates in conjunction with at least one human verifier to verify the signed transaction.

12. The computer program product of claim 8, wherein the transaction order and the cryptogram are received by the input bridge module via a single use, unidirectional temporary connection that is discarded in response to the transaction order and the cryptogram being transferred to the input bridge module; wherein the signed transaction is transferred from the output bridge module to the online module via a single use, unidirectional temporary connection that is discarded in response to the transaction being transferred to the online module.

13. A computer-implemented method, comprising:
connecting to an online module for receiving transaction orders;
disconnecting from the online module in response to receiving the transaction orders;
provisioning a signing service having a hardware security module for signing transactions derived from the transaction orders;
deprovisioning the signing service in response to the transactions being signed;
connecting to the online module for returning the signed transactions to the online module; and
disconnecting from the online module in response to return of the signed transactions.

14. The computer-implemented method of claim 13, wherein the signing service runs on a virtual machine.

15. The computer-implemented method of claim 13, wherein the signing service runs on a container.

16. The computer-implemented method of claim 13, wherein a messaging service module positioned between the online module and the signing service is used to receive the transaction orders and return the signed transactions, wherein the messaging service module is never connected to both the online module and the signing service at the same time.

17. The computer-implemented method of claim 13, wherein the method is performed in a cloud.

18. The computer-implemented method of claim 13, wherein the transaction orders are received via a single use, unidirectional temporary connection that is discarded in response to the transaction orders being transferred; wherein the signed transactions are returned to the online module via a single use, unidirectional temporary connection that is discarded in response to the transaction being returned to the online module.

19. A computer program product for protecting a private key in a remote cold storage environment, the computer program product comprising:
one or more computer readable storage media, and program instructions collectively stored on the one or more computer readable storage media, the program instructions comprising program instructions to perform the method of claim 13.

20. A system, comprising:
a processor; and
logic integrated with the processor, executable by the processor, or integrated with and executable by the processor, the logic being configured to perform the method of claim 13.
